(19) United States
(12) Patent Application Publication
(10) Pub. No.: US 2012/0303515 A1
(43) Pub. Date: Nov. 29, 2012

(54) ORIGINATING LOANS USING ONLINE LOAN MANAGEMENT TOOL

(75) Inventor: Jonathan J. Guida, Patchogue, NY (US)

(73) Assignee: CLICK TO CLOSE MORTGAGE CORPORATION, Patchogue, NY (US)

(21) Appl. No.: 13/478,141

(22) Filed: May 23, 2012

Related U.S. Application Data
(60) Provisional application No. 61/490,154, filed on May 26, 2011.

(51) Int. Cl. G06Q 40/02

(52) U.S. Cl. 705/38

(57) ABSTRACT

The present disclosure describes systems, methods, and computer-readable media for managing a loan process online. The present disclosure provides for providing a web site for originating a loan, the web site hosted by at least one server in communication with a network; receiving a borrower's information via a loan application module; calculating at least one loan option for the borrower based on the borrower's credit information via a pricing module and presenting the at least one loan option to the borrower via an interface; receiving a desired closing date selected by the borrower and calculating at least one due date based on the selected closing date via a scheduling module; receiving required documents for the loan via an initial documents module; and scheduling a closing date, via a closing module, based on the at least one due date and received required documents.

### PRIORITY

This application claims priority on U.S. Provisional Patent Appl. No. 61/490,154, filed May 26, 2011, entitled “ORIGINATING LOANS USING ONLINE LOAN MANAGEMENT TOOL”, the content of which is hereby incorporated by reference in its entirety.

### NOTICE OF MATERIAL SUBJECT TO COPYRIGHT PROTECTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to lending money from a financial institution to a borrower, and more particularly relates to an online tool for managing the loan process.

### BACKGROUND

The following is a breakdown of the steps involved in the entire mortgage process as it exists today. In the following description, the terms client, customer, and/or borrower will be used interchangeably to refer to a person or entity desiring to obtain a loan.

In step #1, a customer may be interested in possibly refinancing a loan or purchasing an original home loan. Most customers today go online to look at interest rates to see what their monthly payment would be, and also to see if it makes sense financially. If it seems to them that the numbers check out, they may go a step further by either filling out a brief questionnaire online or calling a bank directly. In either scenario, a bank loan officer or customer service employee may solicit the customer as to the benefits of refinancing or borrowing. If a customer is still interested and wants to go further, they are asked a list of questions. These questions may be in the form of a residential mortgage application or form 1003. The person on the other end of the line probably has no prior knowledge of this person and is simply going down a “shopping list” of questions they must ask. Once that portion of the transaction has been completed, the loan process advances to step 2.

In step #2, the client's assets and liabilities are reviewed, as well as their credit score, which is usually one of the most important aspects of qualifying for a mortgage. At this point, the loan originator will require the borrower's social security information in order to pull their credit information, e.g., the client's credit score. The loan originator goes over the customer's credit report and verifies whether their credit looks as it should. For refinancing, they will also discuss any possible debts that the client may want to pay off through the refinance transaction.

In step #3, a loan officer will have obtained most of the client's loan application data as well as looked at the credit report. The client or borrower may want to know what they qualify for in regard to their interest rate, payment, and term. The loan officer gives the client a quote based on various factors and will choose a mortgage product that best suits their needs. This quote is mostly based on information that has not yet been verified, such as home value, household income, and other factors.

In step #4, after a borrower or client has been given a complete loan application, they must also be sent loan disclosures by law within 3 business days. These disclosures will include documents such as a good faith estimate, truth in lending statement, borrower's authorizations, and a right to cancel. Although the borrower has not agreed contractually to anything at this point, it is a severe violation for a lending institution not to follow these practices. After the borrower has received these disclosures, they will sign them and then send an email or fax back to the lending institution. Only at this point can an appraisal be paid for. (An appraisal may be scheduled prior to getting the disclosures back from the borrowers, but no money can be exchanged until these documents are received.)

In step #5, while the loan appraisal is being set up, there is a brief period of time (about 3-5 days) when the borrower will fax or email most of the borrower's financial statements, e.g., W2's, Form 1040 tax return documents, pay stubs, and mortgage statements. These documents are typically called initial loan documents, which usually provide enough documentation that a bank or other financial institution can make a preliminary loan commitment. This is a commitment to lend but does not legally bind any party to such a transaction at this time. After the loan commitment, there are usually many things that need to be done on the bank's end in order for the bank to lend. For example, the bank may need to obtain a title report, full residential appraisal, fraud checks, background checks, and so on. There are typically extra things that are needed from the borrower's end on top of the initial documents that were requested. When the borrower fulfills these conditions to the bank, a closing date can be set.

### SUMMARY

The present disclosure describes systems, methods, and computer-readable media for managing a loan process online. The present disclosure provides for providing a web site for originating a loan, the web site hosted by at least one server in communication with a network; receiving a borrower's information via a loan application module; calculating at least one loan option for the borrower based on the borrower's credit information via a pricing module and presenting the at least one loan option to the borrower via an interface; receiving a desired closing date selected by the borrower and calculating at least one due date based on the selected closing date via a scheduling module; receiving required documents for the loan via an initial documents module; and scheduling a closing date, via a closing module, based on the at least one due date and received required documents.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a block diagram illustrating a system for communicating data and information, according to various implementations of the present disclosure.

FIG. 2 is a block diagram illustrating an embodiment of the web server shown in FIG. 1, according to various implementations of the present disclosure.

FIG. 3 is a block diagram illustrating an embodiment of a loan management program, according to various implementations of the present disclosure.

FIGS. 4-11 are screen shots of various user interfaces provided by the loan management program of FIG. 3.

FIG. 12 is a flow chart illustrating a method for managing a loan process according to various implementations of the present disclosure.

### DETAILED DESCRIPTION

The present disclosure describes systems, methods, and computer-readable media for managing a loan process online. In some implementations, the loan process may include the process of obtaining a mortgage for a home loan, refinancing a mortgage loan, or obtaining other types of loans. The loan process may include an online platform that leads customers through the steps needed to easily obtain a loan.

As described in the present disclosure, a web site (www.clicktoclosemortgage.com) is provided by Click to Close Mortgage Corporation of New York, N.Y. This innovative company brings together many different aspects of online mortgage origination platforms to provide customers with low cost transactions and an easy way of completing a somewhat arduous task. This system was set up by a group of loan originators. One objective of creating this system was to provide the client/borrower with a relatively stress-free mortgage process. There are many elements to originating a mortgage loan, as explained above. The present disclosure provides various systems and methods that have been developed to assist customers with navigating this process. Each of the various processes involved in obtaining a mortgage or refinancing a loan may be provided under a single company using a single web site.

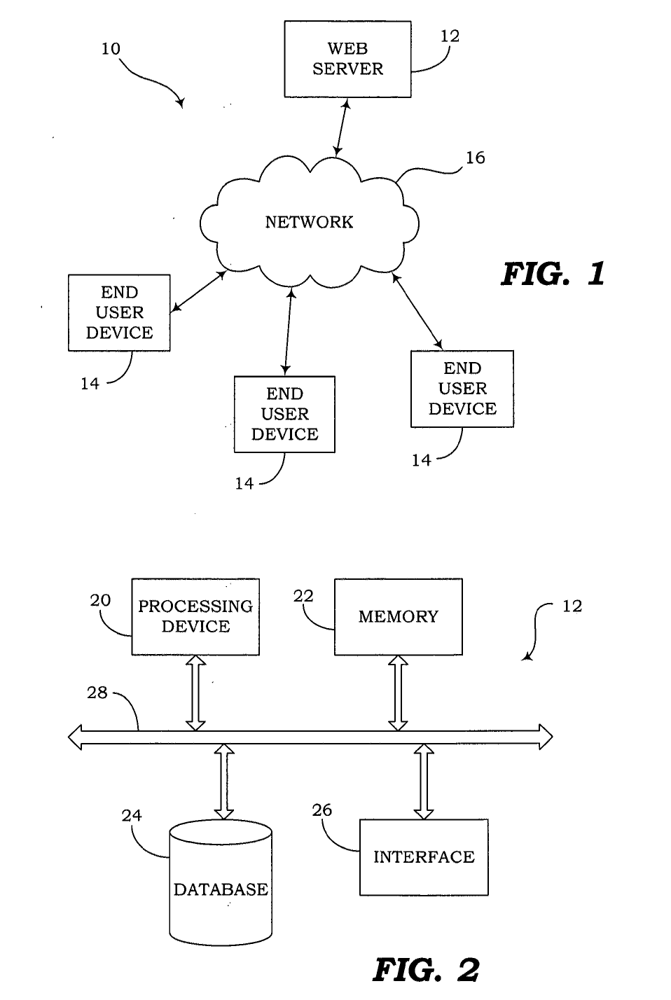

FIG. 1 is a block diagram showing an embodiment of a system 10 for enabling communication between a number of components. The system 10 includes a web server 12 and one or more end user devices 14. Communication between the web server 12 and end user devices 14 is possible via a network 16 (e.g., the Internet), which may include any suitable wired or wireless communication components. The web server 12 is configured to provide web pages and other resources to an end user device 14 when accessed by the end user device 14. The web pages, as explained in more detail below, provide assistance to a borrower to lead the borrower through the loan process.

FIG. 2 is a block diagram showing an embodiment of the web server 12 shown in FIG. 1. In this embodiment, the web server 12 includes a processing device 20, memory 22, a database 24, and an interface 26, each interconnected via a bus 28. The interface 26 is configured to connect the web server 12 to the network 16 to allow the web server 12 to transfer data and information between the database 24 and the end user devices 14 as needed. The web server 12 may include other components as needed to provide an accessible web site for borrowers. Some web pages of the web site may have minimal security to allow any end user device 14 to investigate the web site to determine if a user wishes to obtain a loan through the process described herein. Other web pages may have higher levels of security for allowing borrowers to safely transmit sensitive personal and financial information through the network 16.

The processing device 20 may be a general-purpose or specific-purpose processor or microcontroller for controlling the operations and functions of the web server 12. In some implementations, the processing device 20 may include a plurality of processors for performing different functions within the processing device as designed.

The memory 22 and database 24 may each include one or more internally fixed storage units, removable storage units, and/or remotely accessible storage units, each including a tangible storage medium. The various storage units may include any combination of volatile memory and non-volatile memory. For example, volatile memory may comprise random access memory (RAM), dynamic RAM (DRAM), etc. Non-volatile memory may comprise read only memory (ROM), electrically erasable programmable ROM (EEPROM), flash memory, etc. The storage units may be configured to store any combination of information, data, instructions, software code, etc.

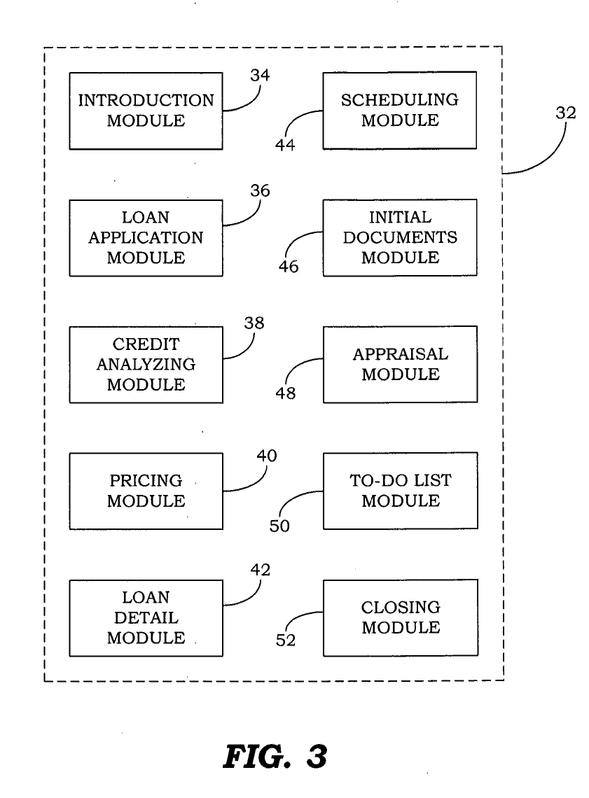

FIG. 3 is a block diagram showing an embodiment of a loan management program 32. The loan management program 32 may be implemented in hardware, software, firmware, or any combinations thereof. In some embodiments, the loan management program 32 may be implemented in software or firmware that is stored on the memory 22 and that is executable by a suitable instruction execution system (e.g., the processing device 20). If implemented in hardware, the loan management program 32 may be incorporated in the processing device 20 using discrete logic circuitry, an application specific integrated circuit (ASIC), a programmable gate array (PGA), a field programmable gate array (FPGA), or any combinations thereof.

The logical instructions, commands, and/or code of the loan management program 32 may be embodied on a computer-readable medium. The computer-readable medium may be any medium that can contain, store, communicate, propagate, or transport programs for execution by an instruction execution system or device. The computer-readable media can include one or more suitable physical media components that can store the software, programs, or computer code for a measurable length of time. The functionality of the loan management program 32 may be represented by flow diagrams where each block may represent a module, segment, portion of code, etc., which comprises one or more executable instructions for performing the specified logical functions. It should be noted that the functions described herein may occur in a different order than described, depending on the particular functionality involved.

In the embodiment of FIG. 3, the loan management program 32 comprises an introduction module 34, a loan application module 36, a credit analyzing module 38, a pricing module 40, a loan detail module 42, a scheduling module 44, an initial documents module 46, an appraisal module 48, a to-do list module 50, and a closing module 52. In some embodiments, one or more modules of the loan management program 32 may be associated with one or more web pages, wherein these web pages may contain a user interface allowing interaction with a user.

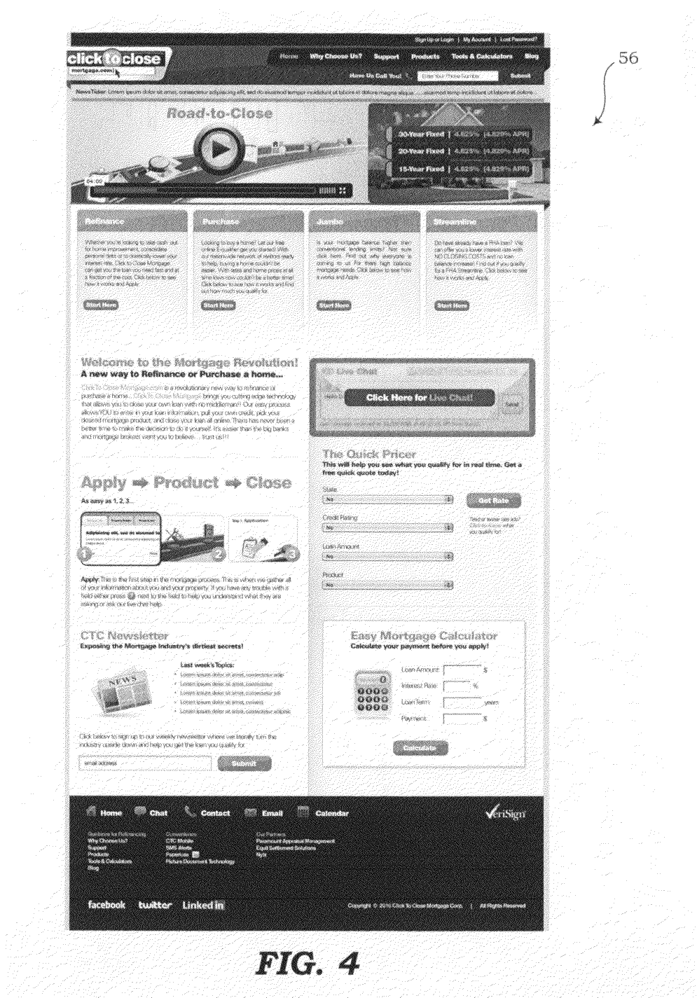

FIG. 4 is a screen shot showing an embodiment of a user interface 56 associated with the introduction module 34 shown in FIG. 3. The user interface 56 may be considered as a main web page or home page of the web site provided by the web server 12. The main web page may be considered a call out to all prospects on the site. The user interface 56 includes an introduction video explaining what services are provided by the loan management company and how the customer can proceed through the loan process using the single web site. It is believed that providing the multiple steps to complete the loan, from loan application to the actual closing of the loan, is revolutionary in the lending industry.

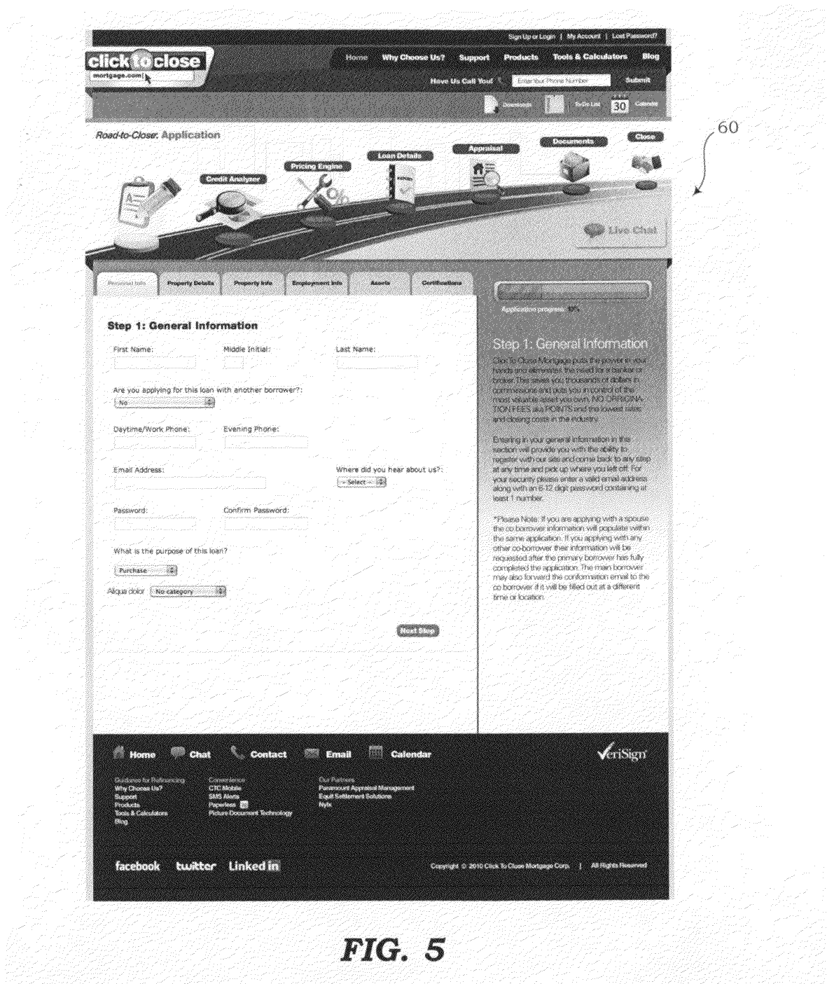

FIG. 5 is a screen shot showing an embodiment of a user interface 60 associated with the loan application module 36 shown in FIG. 3. After a borrower has reviewed the introductory information about how the loan process is accomplished by the web site, the borrower may decide to proceed with a transaction. The user interface 60, generated by module 36, may be presented to provide the potential customer with access to a residential loan application (e.g., Uniform Residential Loan Application Form 1003). The borrower is asked to fill out their information along with setting up a login in and password so they can later have access to this information. Once the borrower fills out the Form 1003 information, they are guided along the mortgage process, which is referred to herein as the “Road to Close.” This Road to Close will bring the borrower through a virtual rendition of a road while they complete the steps of the residential loan application, as well as the other steps of the closing process.

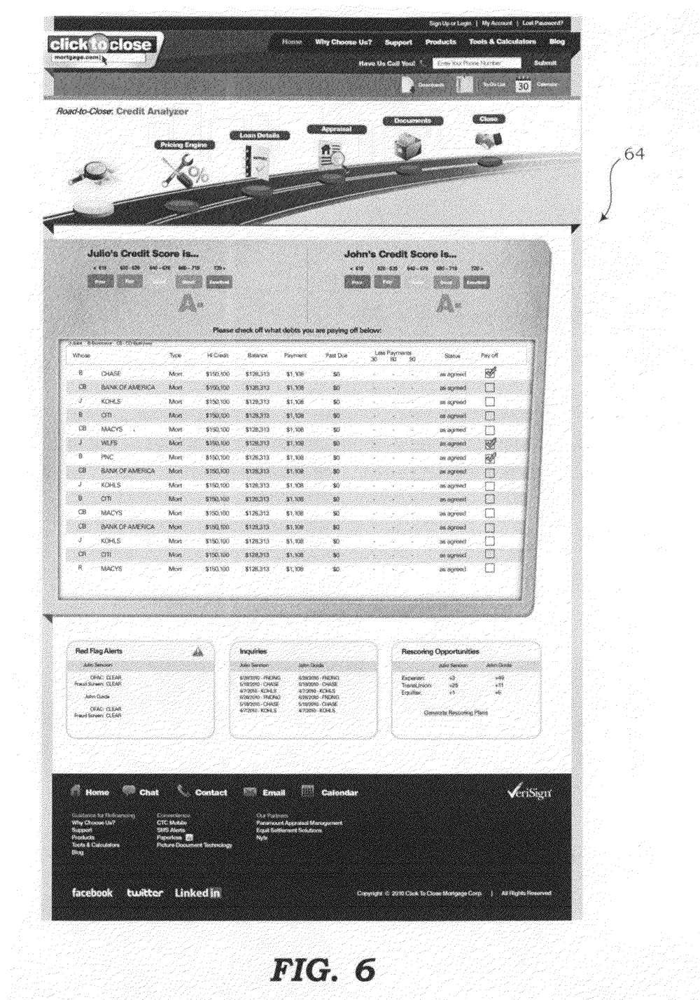

FIG. 6 is a screen shot showing an embodiment of a user interface 64 associated with the credit analyzing module 38 shown in FIG. 3. The user interface 64 includes a Credit Analyzer, executed by the credit analyzing module 38, and is a second step in the Road to Close. The Credit Analyzer is a service that was developed to allow the customer to retrieve a report of the customer's credit worthiness. The credit analyzing module 38 retrieves credit information of the client from commercially available databases via network 16, e.g., from remote servers, service providers, etc. This may be based on any number of factors, including, for example, one or more credit reports or credit scores from various credit bureaus. Not only are their credit reports displayed, but also other liabilities may be displayed as they might appear on a credit report. The user interface 64 (e.g., credit analyzer page) will give the consumer one of the following credit ratings: poor, fair, good, great, and excellent.

The Credit Analyzer is configured to list any collection accounts on the page as well as any judgments and/or liens. If there are collections or judgments, a new page or window may be displayed that asks if the customer has sufficiently satisfied the judgments or liens. The customer may answer with a selection of yes or no check boxes. If they have been satisfied, the information of the judgments or liens will be addressed again in a later process through the “to-do list,” as explained in more detail below. In the user interface 64, the customer may be prompted to add any remaining debts that may or may not be listen on their report. The user interface 64 may also present tips for customers to improve their credit scores.

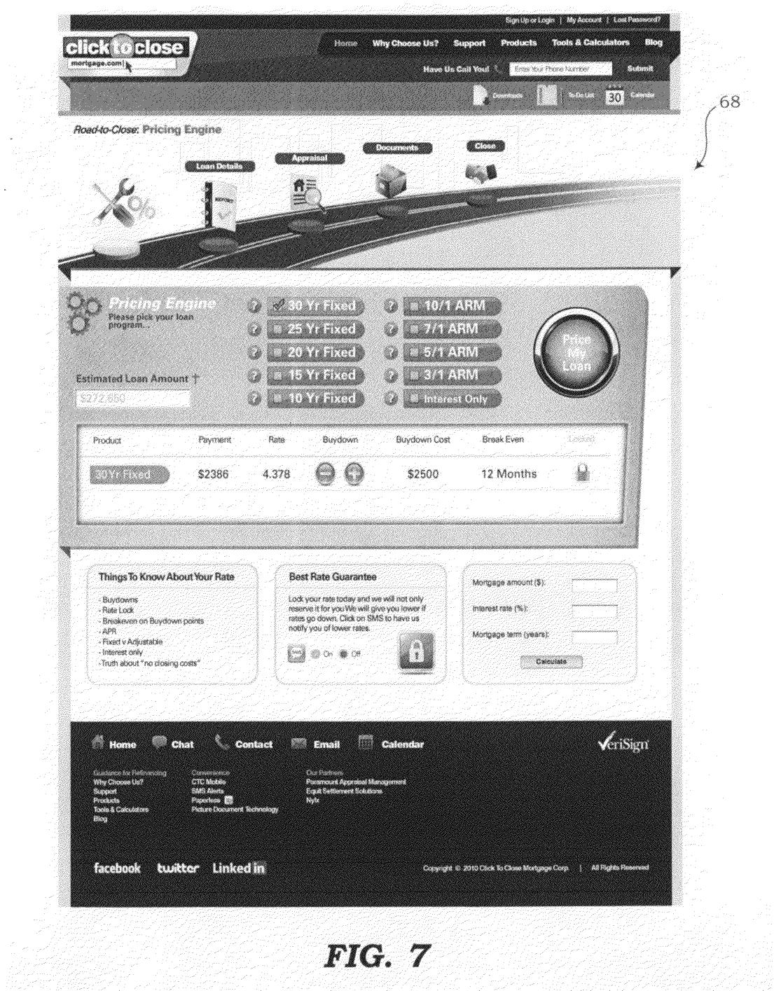

FIG. 7 is a screen shot showing an embodiment of a user interface 68 associated with the pricing module 40 shown in FIG. 3. After the borrower has established their credit worthiness and determined what liabilities they will be paying off in the credit analyzer section, they will be brought to the user interface 68, which comprises a Pricing Engine, executed via the pricing module 40. Based at least one their credit worthiness, the user interface 68 may be configured to display (based on the information so far) what the borrower qualifies for and also what loan amount will be used to price their loan. The borrower is enabled to select a type of loan (e.g., 30 yr. fixed, 25 yr. fixed, etc.) and the Pricing Engine determines costs based on what the client selected. The user interface 68 also allows the borrower to choose what programs and products they want on their loan.

Next to each product, the user interface 68 displays a help icon (e.g., a question mark symbol), which when clicked provides an explanation of the selected product in detail. When they choose their loan product, the loan will appear as selected along with what the payment, interest rate, buy down, buy down cost, and whether the loan is locked or not. Below the pricing engine screen, the user interface 68 includes a section that allows the borrower to calculate a simple mortgage payment to help them choose the correct payment threshold for their needs. Additionally, the user interface 68 include a section to illustrate a break even point that shows clients how long in months it will take to recoup their buy down cost.

The user interface 68 may also be configured to provide a best rate guarantee section below the Pricing Engine that allows the client to click this best rate guarantee. The client may also be given the option to be notified through Short Message Service (SMS) if the loan interest rate goes below the rate that the borrower locked in at. SMS is a text communication service component of phone, web, or mobile communication systems, using standardized communications protocols that allow the exchange of short text messages between fixed line or mobile phone devices. SMS text messaging is the most widely used data application in the world, with 2.4 billion active users, or 74% of all mobile phone subscribers. The term SMS is used as a synonym for all types of short text messaging as well as the user activity itself in many parts of the world. SMS as used on modern handsets was originated from radio telegraphy in radio memo pagers using standardized phone protocols and later defined as part of the Global System for Mobile Communications (GSM) series of standards in 1985 as a means of sending messages of up to 160 characters to and from GSM mobile handsets. Since then, support for the service has expanded to include other mobile technologies such as ANSI CDMA networks and Digital AMPS, as well as satellite and landline networks. Most SMS messages are mobile-to-mobile text messages though the standard supports other types of broadcast messaging as well. The web server 12 is believed to be unique in its ability to notify borrowers by a SMS message for certain situations, such as when interest rates go down.

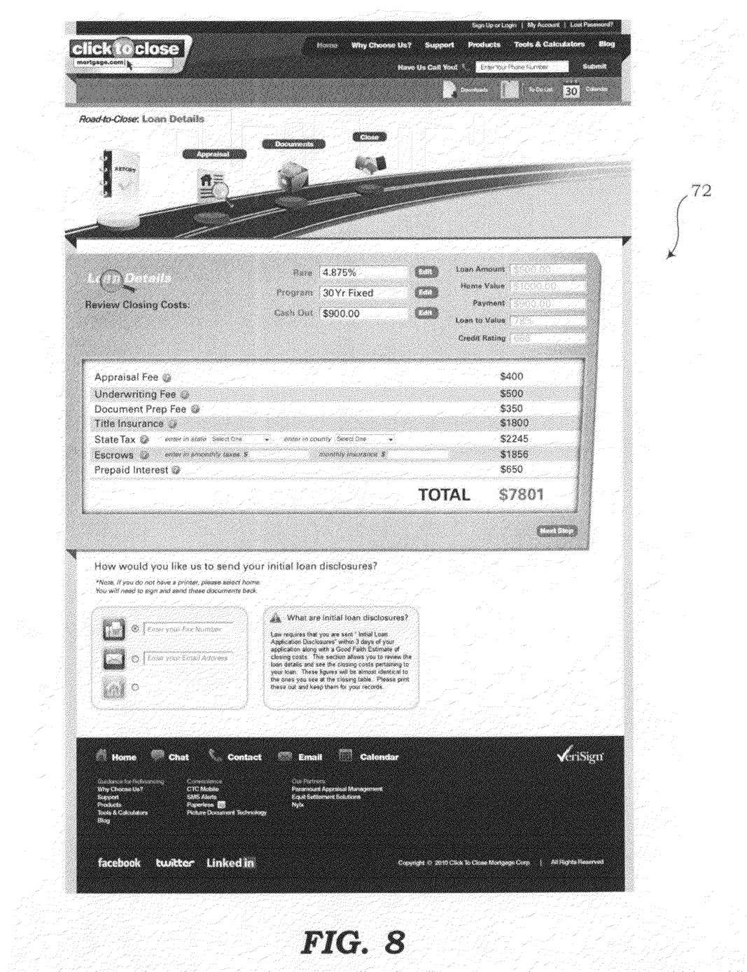

FIG. 8 is a screen shot showing an embodiment of a user interface 72 associated with the loan details module 42 shown in FIG. 3. The loan details module 42 is configured to calculate specific fees, taxes, initial escrow payment, interest, and other various costs included in the closing costs. The calculations are based at least on information entered and/or selected in the Pricing Engine shown in FIG. 7.

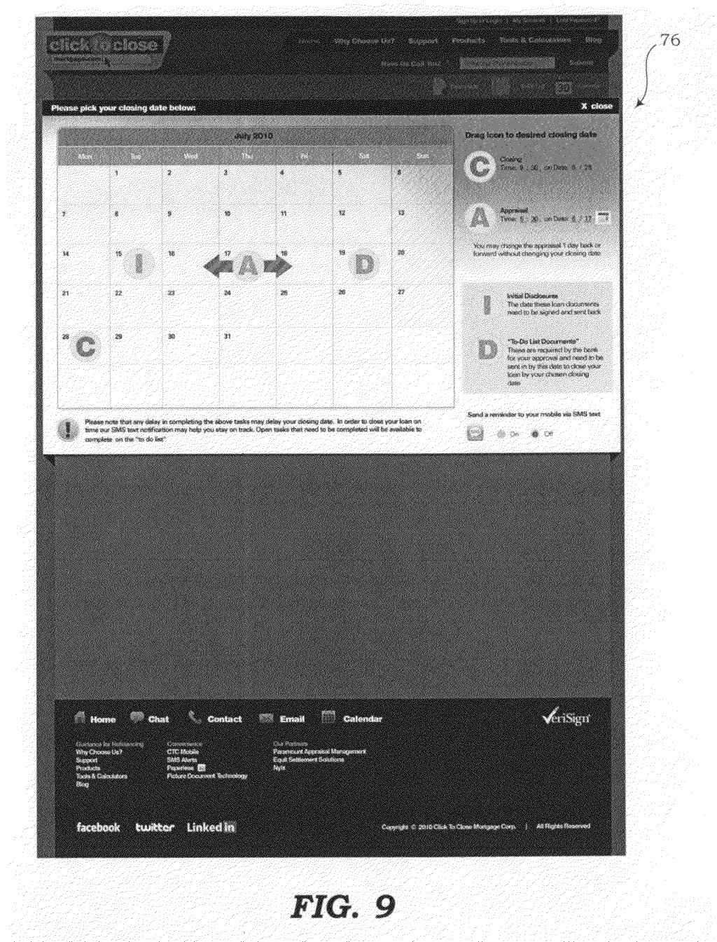

FIG. 9 is a screen shot showing an embodiment of a user interface 76 associated with the scheduling module 44 shown in FIG. 3. An attractive feature of the loan management program 32 is the integration of online web applications, Form 1003 access, credit pulling technology, mortgage pricing engine, and appraisal ordering. An automatically generated calendar is shown in the user interface 76. The calendar displays when documents are due for submission. The calendar is generated in response to a page, screen, or window that asks the borrower when they wish to close on the loan. When the borrower requests a date for closing on the loan, the user interface 76 is presented. This interface may be referred to as “My Calendar.” The interactive calendar allows the borrower to drag the symbol “C” (i.e., representing “closing”) to their desired close date on the calendar. In some embodiments, the borrower may enter the date in any other suitable manner, such as by typing the date in an input field. Once the symbol C is placed on the desired date (e.g., July 28^{th} in the illustrated example), the scheduling module 44 is configured to automatically determine and populate three other milestones onto the calendar on interface 76. These other dates are represented by symbols, “I,” “A,” and “D.” The scheduling module 44 determines the other dates based on typical lending schedules that may provide a smooth transaction. Furthermore, the other dates may be predetermined by the institution providing the loan. In any case, the other dates are adjustable. The other dates give sufficient time for certain actions to be performed in order that the borrowers may close on the date requested. The other milestones are described as follows:

I=Initial Disclosures—This date is when the loan management company needs to have the initial disclosures signed and dated by the borrower. When these initial disclosures are received, the loan management company can begin the actual lending process.

A=Appraisal—This date is when the appraisal is due. As indicated by the arrows, the borrower may change this date one day before or one day after without causing the loan management program 32 to suggest a change of the closing date. Otherwise, if the borrower cannot for whatever reason schedule their appraisal within this three day period, the loan management program 32 creates a pop up window indicating that their closing date needs to be pushed back.

D=To-do list Documents—This date is when the borrower needs to complete of items on a “to-do list.” The to-do list is used as a way to communicate between the web server 12 and the borrower's end user device 14. In essence, the to-do list is a way that the web server 12 is able to get information from the borrower. When a borrower initiates a loan application, there are standard documents that are needed to begin a loan application. Some of these things include the borrower's W2 forms, mortgage statements, home owners insurance documents, tax returns, and paystubs, to name a few.

C=Closing—This date is the date that the borrowers originally chose for closing. The borrower is able to choose between an online web closing process (e.g., such as through webex or other on-line loan processing site) or a traditional closing where a title closer comes to the table.

My Calendar, as presented via user interface 76, is configured to utilize SMS technology that has been described above. This allows the borrower to turn it off or on at any time to notify them of their milestones as previously stated. This SMS feature helps to keep the borrower on track to ensure a timely closing. The My Calendar function allows the borrower to pick a closing date in the beginning of the process and then automatically populates the other milestones into the calendar. These milestones will be set in order that the loan management program 32 may remind the borrower of the dates through SMS text notification, which is described above.

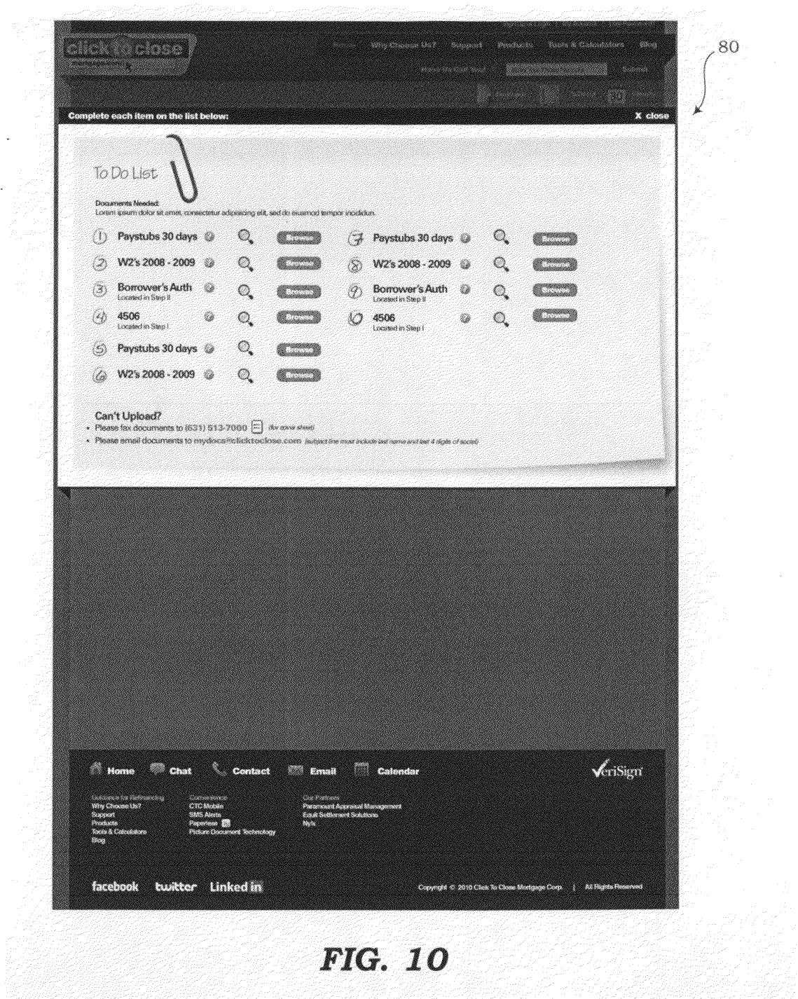

FIG. 10 is a screen shot showing an embodiment of a user interface 80 associated with the to-do list module 50 shown in FIG. 3. The user interface 80 is essentially a portal that allows the client to not only see initial documents needed for an initial approval, but also to see any outstanding documents and/or conditions listed on the to-do list. The user interface 80 provides a display that is simple to read and understand and may assist the borrower to complete and close their loan. The to-do list is a useful tool of the loan management program 32 and in essence takes the place of having a loan officer or mortgage banker collect these documents. It allows the client to get their documents directly to the bank without the need for a 3^{rd} party. Eliminating one or more middlemen may play a big part when dealing with costs and simplifies the procedure for the borrower because they have one contact to speak to for all stages of the loan process. The borrower may also more easily know who they are communicating with. This process is believed to be a new way that loan documents are transacted via the network 16 (e.g., the Internet). It is believed that this type of communication has not been done in this way before.

When transferring documents, there is more than one way that a borrower may submit their information via the to-do list. The following provides four ways in which a borrower may submit their information. The documents may be sent through a browse and upload method. If this method is used, the information will be visible to the borrower substantially instantaneously. Documents may also be sent through email, where the borrower may follow a certain naming format (e.g., putting the borrower's last name and last four digits of the borrower's Social Security number in the subject line) and attach a document with the information. Also, the borrower may print out a fax cover sheet and fax in their documents. The borrower may also take a photograph using remote deposit capture technology. When the information is uploaded, the borrower is able to see the information.

The loan management program 32 enables the borrower to go directly to a website and upload their mortgage documents in any one or more of these four ways. Although this process is usually done through fax or email, this to-do list portal allows direct communication.

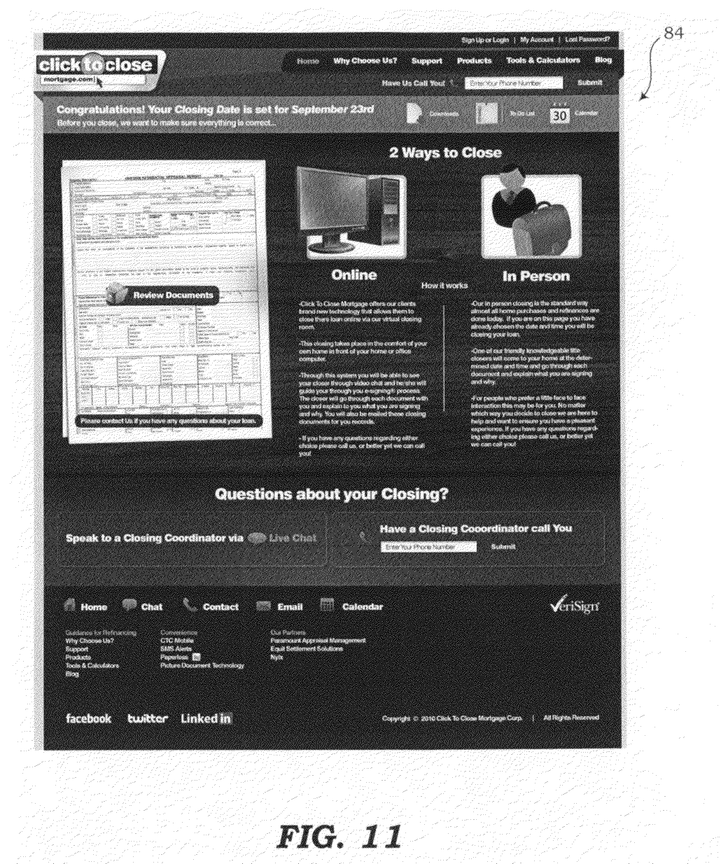

FIG. 11 is a screen shot showing an embodiment of a user interface 84 associated with the closing module 52 shown in FIG. 3. Via interface 84, a borrower is able to choose the closing method and review there closing package online before they close. The borrower is enabled to choose to conduct the closing online or in-person. If the online method is selected, the borrower will be presented with a virtual closing room, on the closing date. In the virtual closing room, video chat is employed for the borrower to interact with a loan closer, i.e., a real person, who will guide the borrower through an e-signing process. The loan closer, via video chat, will be enabled to take the borrower through each document and explain what the documents is and why the borrower is signing same. After the loan is closed, the closing documents will be sent to the borrower, for example, via e-mail, traditional mail, etc. If the in-person method is selected, the closing will take place in a face-to-face manner as is traditionally done.

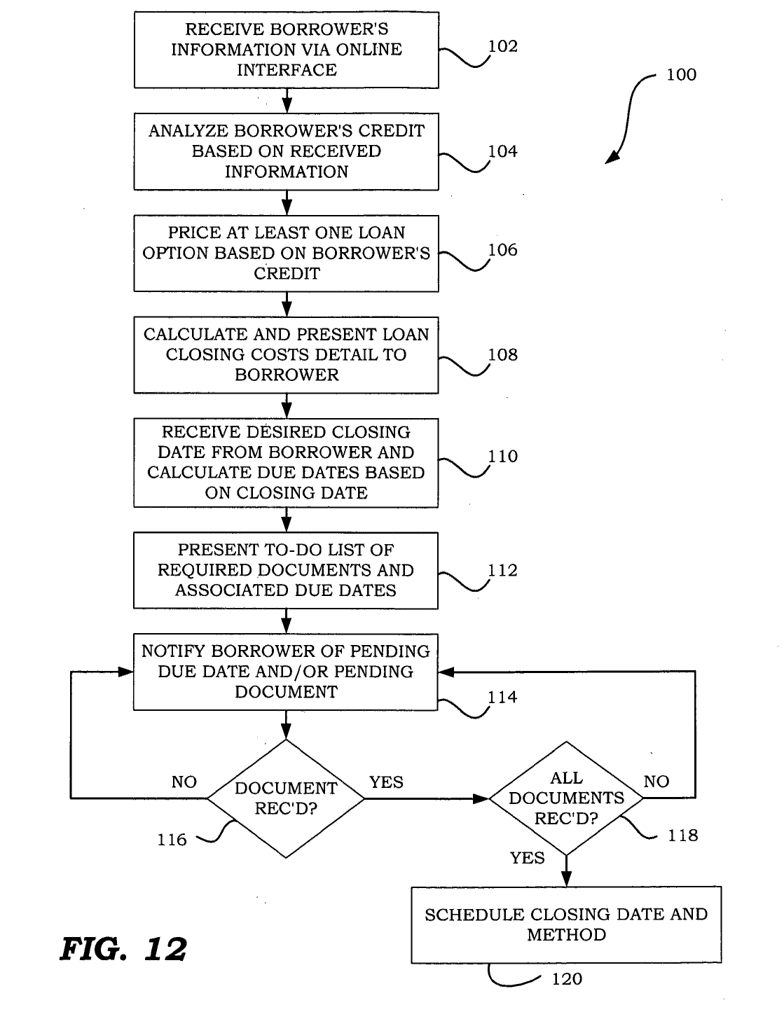

Referring to FIG. 12, a method 100 for managing the loan process as executed by the web server 12 is illustrated in accordance with at least one embodiment of the present disclosure. It is to be understood that because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

Initially, in step 102, the web server 12 receives the borrower's information via user interface 60 generated by the loan application module 36. The credit analyzing module 38 analyzes the borrower's credit based on the received information, in step 104. Some of the information may be retrieved from other web sites such as the client's credit score and is then presented via interface 64. In step 106, the pricing module 40 will calculate at least one loan option for the client based on the client's credit information and will present same via interface 68.

In step 108, the loan detail module 42 calculates the loan closing costs and present same to the user via interface 72. In step 110, the scheduling module 44 receives a desired closing date from the borrower and calculates other pertinent due dates based on the selected closing date. The calculated due dates are present to the user via interface 76. A to-do list is generated via the to-do list module 50 and presented to the user via interface 80, step 112. In certain embodiments, the to-do list module will notify the borrower of pending due dates and/or pending documents, for example, via a SMS text message, step 114.

In step 116, the web server 12 will determine if the pending document has been received. For example, the received document may be sent to the initial documents module 46 for processing. In other embodiments, the received document may be sent to the appraisal module 48 for processing. In step 116, if the pending document was not received, the process will revert to step 114 and another notification will be sent to the borrower for example via SMS, e-mail, a phone call, etc. If the document was received in step 116, the web server 12 will then determine if all necessary documents for the loan have been received in step 118. If they have not, the process will go back to step 114 and will notify the borrower of any pending documents or due dates. Alternatively, if all documents have been received, the closing module 52 will schedule the closing date and enable the borrower to select the closing method via interface 84, step 120.

In some embodiments, the loan management program 32 may be associated with a different, second web site and embodied in a different computer system. The second web site may be a web page that allows a realtor to access the loan information for one or more clients. The second web site will allow a realtor to track a loan in real time. When a borrower is filling out an application on user interface 60, a drop-down field will appear that will asks for their realtor's e-mail address (applies to purchases only). After the client inputs this information, the realtor will be sent a welcome e-mail explaining how to use the website if they are new to it. The realtor will also be sent information regarding the borrowers closing date, when the appraisal is scheduled, so the realtor can be at the home when it is being done, and when the loan is approved. The second web site will also include an SMS feature that will send alerts to the realtor as statuses and milestones change for the borrower, allowing them to stay focused on the client and have open and transparent communication.

In this regard, the second web site may be referred to as a client management system. The second web site enables the realtor to see where their clients are along the process. It also allows them access to certain aspects of the process. For example, the realtor may have access to My Calendar to choose the appraisal time for the borrower because the realtor is the one who needs to give the appraiser access into the home. The SMS feature may be employed to alert the realtor of the appraisal date or other dates which, if any, require action by the realtor. The realtors are given access to certain information for tracking their clients' progress only when given written consent from the borrower.

The loan management program 32 may also establish a tracking connection online between the borrower and the realtor. In this respect, the realtor may use another end user device 14 and be given certain rights as a registered realtor. The client management system allows secure communication between the borrower's end user device 14 and the realtor's end user device 14 via the network 16 and web server 12.

The implementations described herein represent a number of possible implementations and examples and are not intended to necessarily limit the present disclosure to any specific implementations. Instead, various modifications can be made to these implementations as would be understood by one of ordinary skill in the art. Many variations and modifications may be made to the above-described embodiments without departing from the principles of the present disclosure. Any such modifications are intended to be included within the spirit and scope of the present disclosure.

What is claimed is:

1. A method for originating a loan over a network, the method comprising the steps:
providing a web site for originating a loan, the web site hosted by at least one server in communication with the network;
receiving a borrower's information via a loan application module;
calculating at least one loan option for the borrower based on the borrower's credit information via a pricing module and presenting the at least one loan option to the borrower via an interface;
receiving a desired closing date selected by the borrower and calculating at least one due date based on the selected closing date via a scheduling module;
receiving required documents for the loan via an initial documents module; and
scheduling a closing date, via a closing module, based on the at least one due date and received required documents.

2. The method of claim 1, further comprising the step of notifying the borrower of the at least one due date or required documents via a to-do list module.

3. The method of claim 1, further comprising the step of notifying the borrower of the at least one due date or required documents via a text message.

4. The method of claim 3, wherein the at least one due date is the date initial disclosures for the loan are required.

5. The method of claim 4, wherein the at least one due date is the date an appraisal of a property relating to a loan is due.

6. The method of claim 5, wherein the at least one due date is the date when the required documents are due.

7. The method of claim 1, wherein the receiving required documents step includes uploading the required documents and further comprising displaying the received required documents to the borrower.

8. The method of claim 1, further comprising displaying a to-do list to the borrower, the to-do list including a list of the required documents and an associated indication for each item on the list of a status of the item.

9. The method of claim 1, further comprising retrieving at least one credit report of the borrower via a credit analyzing module from a remote server.

10. The method of claim 5, further comprising the step of notifying at least one third party of the appraisal date.

11. A system for originating a loan over a network, the system comprising:
a loan application module configured to receive a borrower's information;
a pricing module configured to calculate at least one loan option for the borrower based on the borrower's credit information and present the at least one loan option to the borrower via an interface;
a scheduling module configured to receive a desired closing date selected by the borrower and calculating at least one due date based on the selected closing date;
an initial documents module configured to receive required documents for the loan; and
a closing module configured to schedule a closing date based on the at least one due date and received required documents.

12. The system of claim 11, further comprising a to-do list module configured to notify the borrower of the at least one due date or required documents.

13. The system of claim 11, further comprising a to-do list module configured to notify the borrower of the at least one due date or required documents via a text message.

14. The system of claim 13, wherein the at least one due date is the date initial disclosures for the loan are required.

15. The system of claim 14, wherein the at least one due date is the date an appraisal of a property relating to a loan is due.

16. The system of claim 15, wherein the at least one due date is the date when the required documents are due.

17. The system of claim 11, wherein the initial documents module is further configured to upload the required documents and the interface is further configured to display the received required documents to the borrower.

18. The system of claim 11, wherein the to-do list module is further configured to display a to-do list to the borrower, the to-do list including a list of the required documents and an associated indication for each item on the list of a status of the item.

19. The system of claim 11, further comprising a credit analyzing module configured to retrieve at least one credit report of the borrower from a remote server.

20. The system of claim 15, wherein the to-do module is further configured to notify at least one third party of the appraisal date.
